(19) United States
(12) Patent Application Publication
(10) Pub. No.: US 2026/0230947 A1
(43) Pub. Date: Aug. 6, 2026

(54) METHODS, ARCHITECTURES, APPARATUSES AND SYSTEMS FOR CELL RESELECTION FOR A WIRELESS TRANSMIT/RECEIVE UNIT

(71) Applicant: InterDigital Patent Holdings, Inc., Wilmington, DE (US)

(72) Inventors: Jongwoo Hong, New York, NY (US); Fumihiro Hasegawa, Westmount (CA); Paul Marinier, Brossard (CA); Arman Shojaeifard, London (GB); Kevin Wanuga, Souderton, PA (US); Moon IL Lee, Melville, NY (US); Remun Koirala, London (GB); Ghyslain Pelletier, Montreal (CA); Benoit Pelletier, Roxboro (CA)

(21) Appl. No.: 19/044,528

(22) Filed: Feb. 3, 2025

(51) Int. Cl. H04W 36/00; H04W 36/30

(52) U.S. Cl. CPC H04W 36/0058; H04W 36/008357; H04W 36/302

(57) ABSTRACT

This disclosure relates to cell reselection. A wireless transmit/receive unit (WTRU) performs sensing measurements using an initial cell based on an initial cell configuration comprising one or more initial cell reselection conditions. The WTRU may receive configuration information indicative of one or more first cells, one or more second cells having sensing capability, and one or more reselection conditions. The WTRU may determine to perform a cell reselection based on the one or more initial cell reselection conditions. The WTRU may identify one or more candidate cells from the one or more first cells based on one or more performance metrics. The WTRU may select a new cell from the one or more candidate cells by determining whether the one or more second cells comprise the new cell. The WTRU may be configured based on the configuration information and the new cell.

### TECHNICAL FIELD

The present disclosure is generally directed to the fields of communications, software and coding, including, for example, to methods, architectures, apparatuses, systems related to prioritized cell (re) selection(s) with sensing capabilities.

### SUMMARY

In accordance with certain representative embodiments of the present disclosure, methods and systems are provided for cell reselection. In certain representative embodiments, a wireless transmit/receive unit (WTRU) performs sensing measurements using an initial cell based on an initial cell configuration comprising one or more initial cell reselection conditions. The WTRU may receive configuration information indicative of one or more first cells, one or more second cells having sensing capability, and one or more reselection conditions associated with each of the one or more first cells, respectively. In certain representative embodiments, the one or more first cells and the one or more second cells are each associated with a location zone. The WTRU may determine to perform a cell reselection based on the one or more initial cell reselection conditions. Based on determining to perform the cell reselection, the WTRU may identify one or more candidate cells from the one or more first cells based on one or more performance metrics. The WTRU may select a new cell from the one or more candidate cells by determining whether the one or more second cells comprise the new cell. In certain representative embodiments, selecting the new cell is based at least in part on determining which candidate cell has the best one or more performance metrics. The WTRU may be configured based on the configuration information and the new cell.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A shows a system diagram illustrating an example communications system, according to one or more embodiments of this disclosure;

FIG. 1B shows a system diagram illustrating an example wireless transmit/receive unit (WTRU) that may be used within the communications system illustrated in FIG. 1A, according to one or more embodiments of this disclosure;

FIG. 1C shows a system diagram illustrating an example radio access network (RAN) and an example core network (CN) that may be used within the communications system illustrated in FIG. 1A, according to one or more embodiments of this disclosure

FIG. 1D shows a system diagram illustrating a further example RAN and a further example CN that may be used within the communications system illustrated in FIG. 1A, according to one or more embodiments of this disclosure;

FIG. 2 shows an illustrative scenario of a sensing device sensing an intruder, according to one or more embodiments of this disclosure;

FIG. 3 shows an illustrative scenario with vehicles that are enhanced with sensing capabilities, according to one or more embodiments of this disclosure;

FIG. 4 shows an illustrative scenario of cell reselection for a mobile WTRU, according to one or more embodiments of this disclosure;

FIG. 5 is a flowchart of illustrative steps for reselecting a cell, according to one or more embodiments of this disclosure;

FIG. 6 shows a diagram of illustrative cells lists for cell reselection, according to one or more embodiments of this disclosure;

FIG. 7 is a flowchart of illustrative steps for reporting information after cell reselection, according to one or more embodiments of this disclosure; and

FIG. 8 is a flowchart of illustrative steps for cell reselection, according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

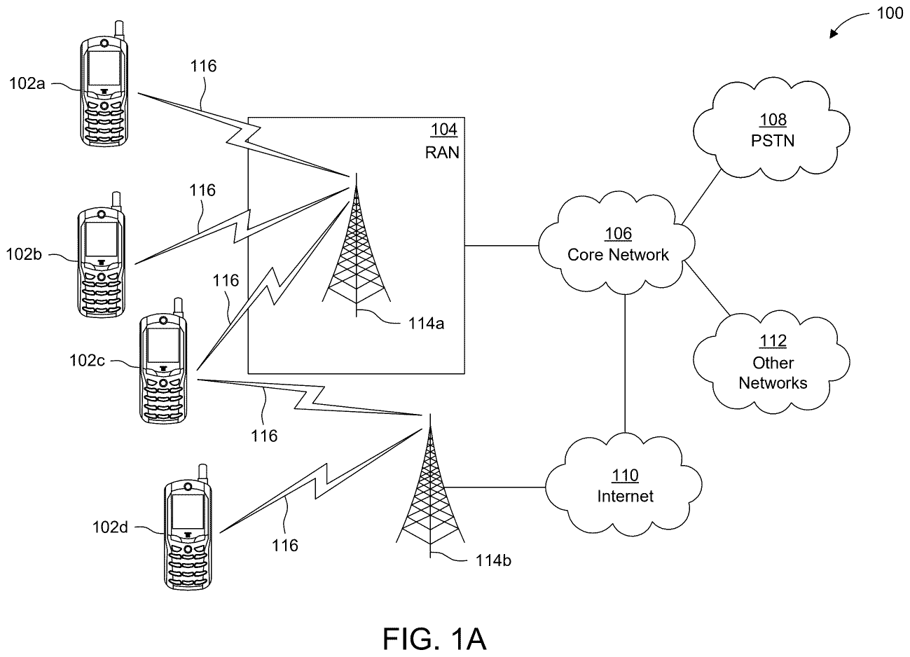

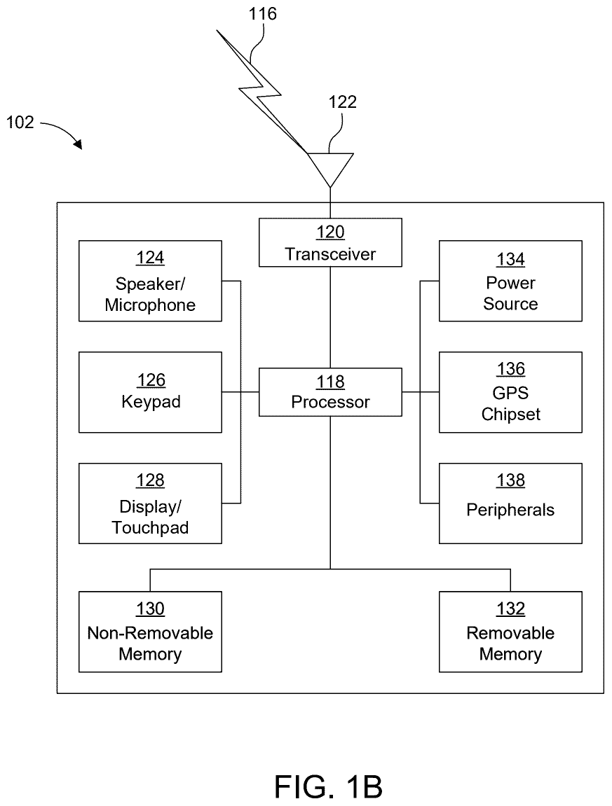

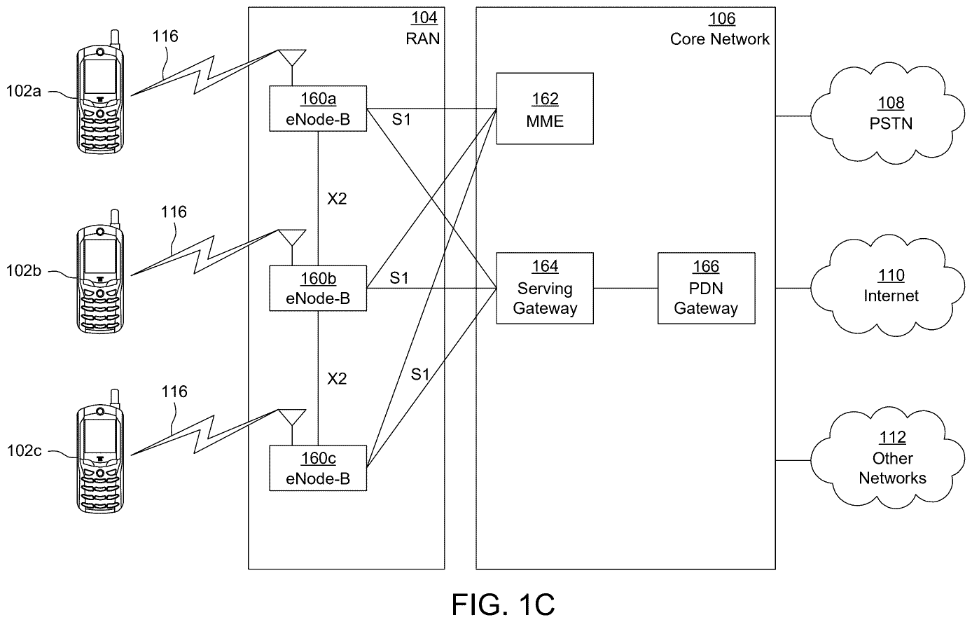

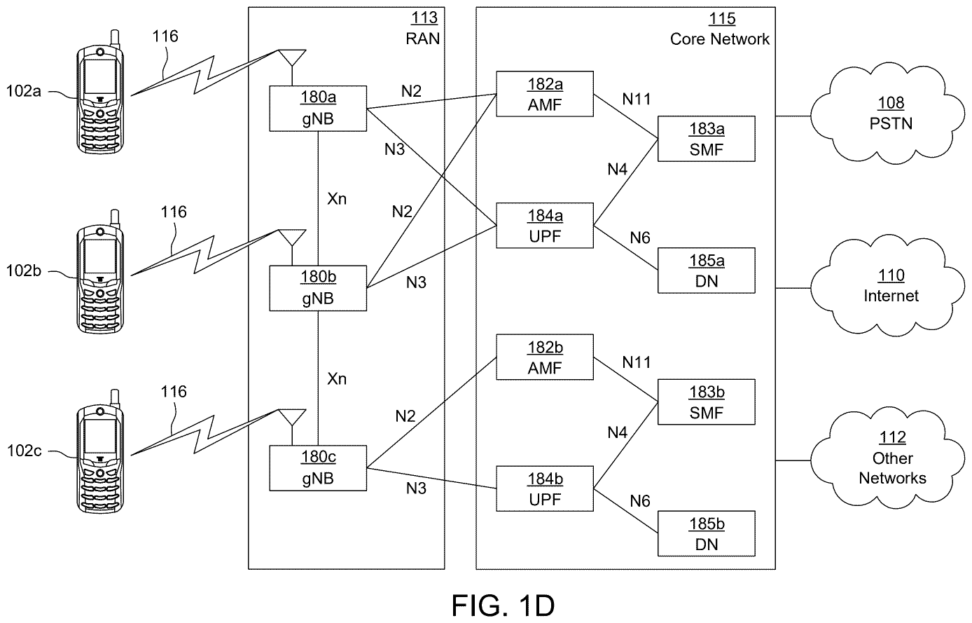

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, if that WTRU includes only one active UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

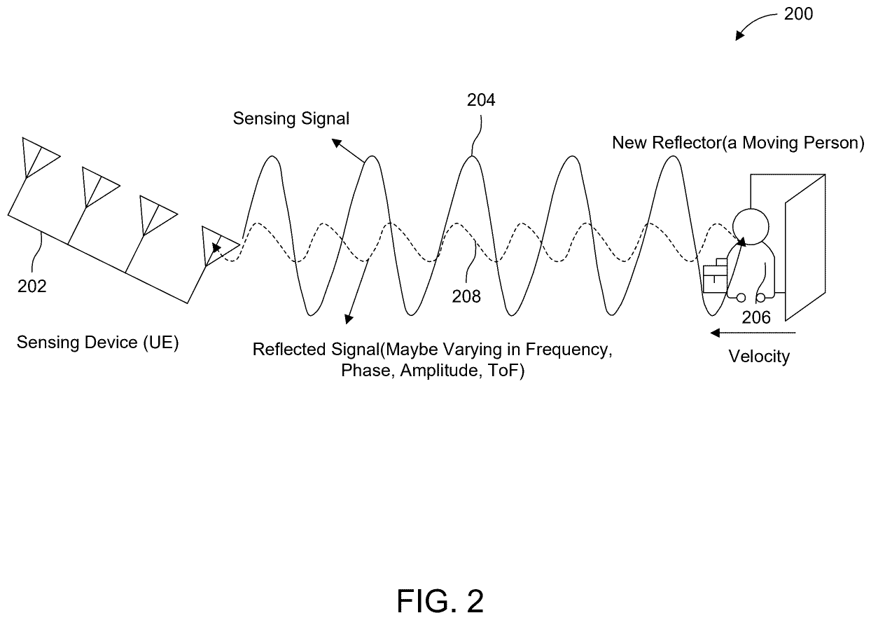

In accordance with one or more embodiments of this disclosure, the devices and systems of FIGS. 1A-1D may be used in connection with devices, systems, and methods for cell reselection. For example, the devices and systems of FIGS. 1A-1D may be used in connection with the devices, systems, and methods described in FIGS. 2-8, according to one or more embodiments of this disclosure.

5G/6G wireless sensing is a technology which enables acquiring information about characteristics regarding an environment and/or objects within an environment. Wireless sensing uses radio waves to determine the distance, range, angle, or instantaneous linear velocity of objects. The 5G/6G wireless sensing service relies on analyzing the transmissions, reflections, and scattering of wireless sensing signals.

Integrated sensing and communication technology enables new services and use cases for various industries. 5G/6G wireless sensing services, as part of a cellular network, provide new possibilities for enhanced usage of the telecommunication infrastructure in areas related to object detection, object tracking, environmental monitoring, and human motion monitoring. It provides input to various verticals such as unmanned ariel vehicles (UAVs), smart homes, or vehicle-to-everything (V2X) technology. Use cases may include but are not limited to the following: object and intruder detection in smart homes, on a highway, on a railway, in a factory, or predefined secure areas around critical infrastructure; collision avoidance and trajectory tracking of UAVs, vehicles, or automated guided vehicles (AGVs); automotive manuvering and navigation; public safety search and rescue; rainfall monitoring and flooding; or health and sports monitoring.

Some use cases may involve non-3GPP type sensors (e.g. radar, camera). 5G/6G wireless sensing service also brings challenges related to confidentiality and privacy. There is a need to protect the sensing data from unauthorized access, interception and eavesdropping, while also complying with regulation and user awareness. Based on certain use cases, it may be desirable to address 5G/6G system support for different use cases and service requirements for Integrated Sensing and Communication (ISAC).

Sensing in smart homes involves indoor or local-area sensing. Considering that people generally spend time indoors, it may be desirable to improve indoor technology user experiences. Various 5G WTRUs (e.g. wearable devices, sensors, smart phones and customer premise equipment (CPE)) may be employed in a home. To enjoy more comfortable and convenient indoor life, various devices may be connected via wireless signals to build a smart home platform. In addition to communication purposes, wireless signals may also be used for sensing (e.g., to monitor the home environment continuously).

FIG. 2 shows an illustrative scenario of a sensing device sensing an intruder, according to one or more embodiments of this disclosure. In scenario 200, a sensing device such as WTRU 202 (which may be the same as any of WTRUs 102a-102d) transmits sensing signal 204. Sensing signal 204 is reflected off intruder 206. As a result, reflected signal 208 is received by WTRU 202. Hence, it may be determined that an intruder has entered. Further analysis may be performed to determine a specific trajectory or path that intruder 206 takes. Generally, in an intruder detection in a smart home scenario, the 3GPP signal measured by WTRU 202 or a network may be influenced by activities of an object indoors or a human. By analyzing and collecting sensing information such as Doppler frequency shift, amplitude change or phase change, the path of an indoor object or human may be detected as shown in FIG. 2.

To support smart transportation and autonomous driving, vehicles and devices may be equipped with sensing technologies. For example, cameras, radar, and light detection and ranging (LiDAR) systems may be used in the automotive industry to maintain the perception for autonomous vehicles at various levels of autonomy. Accurate sensing results are crucial to enable safe and reliable control for vehicles.

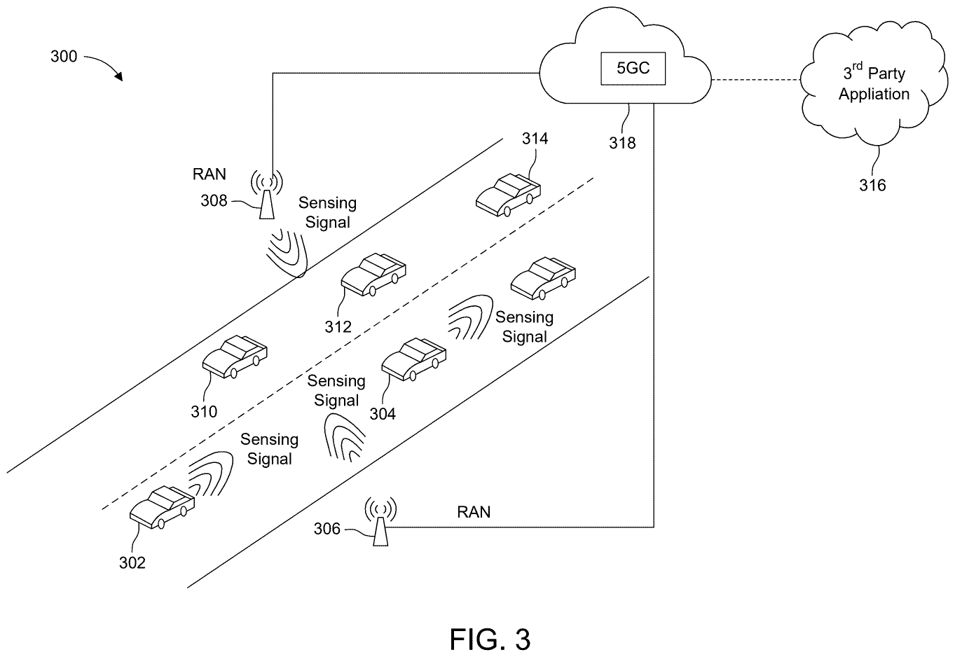

Due to the mounting position of sensors (e.g., 3GPP based sensors), information collected from a single vehicle's sensors may not be sufficient or accurate enough to satisfy advanced automotive use cases (e.g., autonomous driving or coordinated maneuvers). A 5G system may coordinate sensing activities to receive sensing data from various sources and generate sensing results which may be processed by a vehicle. These results may be used for vehicular control and driver assistance (e.g., feed into an automated driving system (ADS)). The 3GPP sensing data collected by the WTRU may be sent alongside relevant sensing information to other sensing entities (including other vehicles, roadside units, and or a network) for further processing. Sensing data may also be shared with a third-party application (as later shown in FIG. 3). The network facilitated NR based sensing described above may improve sensing reliability and quality, enabling new and advanced automotive use cases.

FIG. 3 shows an illustrative scenario with vehicles that are enhanced with sensing capabilities, according to one or more embodiments of this disclosure. In an automotive use case, vehicle 302 and vehicle 304 are equipped with 3GPP-based sensing technology. Non-3GPP sensors (e.g., radar, camera or LiDAR sensors) may also be equipped. Vehicle 302 and vehicle 304 are capable of 5G communications, including direct communication with other vehicles or communication with other 5G systems via RAN entities (e.g., RAN 306 or 308) which may be connected to 5G core network 318. Third party application 316 may receive sensing data for further processing.

When vehicle 302 registers for 3GPP sensing services, the network provides policies and configurations to enable WTRUs (which may be the same as any of WTRUs 102a-102d or 202) to take appropriate actions during sensing (e.g., obtaining 3GPP sensing data from another WTRUs/RAN entities). For example, the policies provided by the network may provide guidance for the following: the discovery of other WTRUs/RAN entities with appropriate NR RF sensing capabilities; when to trigger requests for obtaining measurements; when to stop sending requests for obtaining measurements; messaging formats; communication configurations (e.g., which 5G communication mode to use under certain conditions); or sensing configurations (e.g., selection of a role of type transmitter or receiver or to use by a particular node for a particular sensing task). These polices and configurations may be updated frequently by the network based on network conditions or mobility patterns.

Sensors of vehicle 302 may be blocked by vehicle 304. As a result, vehicle 302 may not be able to adequately detect its surroundings (e.g., detect if there is another vehicle in front). This may result in the vehicle miscalculating the distance required to stop before a traffic light. Vehicle 304 may also reduce the valid sensing region of vehicle 302. As a result, vehicle 302 may incorrectly detect incoming vehicles (e.g., vehicle 310, 312, 314). The blockage of sensors of vehicle 302 may prevent satisfying autonomous driving needs and requirements.

Due to the unsatisfactory autonomous driving needs and requirements of vehicle 302, a WTRU in vehicle 302 is notified that its sensors are blocked and needs 5G system assistance for coordination of sensing services.

With the policies and configurations provided by the 5G system, vehicle 302 may search for neighboring WTRUs or RAN entities or ask the network to provide recommendations for WTRUs or RAN entities (e.g. considering the current network conditions in the target sensing area). The WTRU or RAN recommendations may be based on 3GPP NR RF sensing capabilities (e.g., if a WTRU or RAN entity supports sensing service). This information may be used to discover other vehicles and RAN entities with 3GPP NR RF sensors that may support sensing in the area. In scenario 300, vehicle 302 discovers that vehicle 304 may be useful in providing sensing inputs.

Vehicle 302 establishes a 5G communication connection with vehicle 304 and/or RAN entities 306 or 308. The most suitable 5G communication mode (e.g., broadcast or unicast) is determined by vehicle 302 based on 5G system configurations and policies. The request to establish 5G communication may indicate the information needed to perform sensing (e.g., the additional region to be covered, additional sensing target, or synchronization info).

Based on the information provided by vehicle 302, vehicle 304 sends vehicle 302 3GPP sensing data identifying objects in its surroundings. When 3GPP sensing data is shared between vehicle 302 and vehicle 304, the sharing is expected to be performed in compliance with operator policy on the use of the operator resources (e.g., licensed/unlicensed spectrum).

If vehicle 302 has non-3GPP sensors (e.g., a camera or LiDAR sensor), vehicle 302 may combine the 3GPP sensing data from vehicle 304 with other sensors. Vehicle 302 may share sensing results and non-3GPP sensing data (e.g., from a camera or LiDAR sensor) within the 5G system. Data and other contextual information may then be shared to third-party application server 316 for analysis by a third-party. Contextual information is information forwarded alongside the sensing results which provide context to the conditions under which the sensing results were derived. Contextual information may be used in scenarios where sensing results are to be combined with data from other sources. In case contextual information is required, this information is shared with the appropriate consent, permissions and subject to operator policy.

A downlink reference signal (DL-RS) configuration may contain at least one of the following parameters: a number of symbols; a transmission power; a number of DL-RS resources included in the DL-RS resource set; a muting pattern for DL-RS (e.g., the muting pattern may be expressed via a bitmap); periodicity; the type of DL-RS (e.g., periodic, semi-persistent, or aperiodic); a slot offset for periodic transmission for the DL-RS; a vertical shift of DL-RS pattern in the frequency domain; a time gap during repetition; a repetition factor; an RE (resource element) offset; a comb pattern; a comb size; a spatial relation (e.g., with respect to other DL-RSs or uplink reference signals (UL-RS) such as sounding reference signals (SRS) for positioning purposes); quasi co-location (QCL) information (e.g., QCL target, QCL source) for the DL-RS; a number of transmit receive points (TRPs); an absolute radio-frequency channel number (ARFCN); subcarrier spacing; expected reference signal time difference (RSTD); uncertainty in expected RSTD; start physical resource block (PRB); bandwidth (BW); bandwidth part (BWP) ID; a number of frequency layers; a start/end time for DL-RS transmission; on/off indicators for the DL-RS; a transmit receive point (TRP) ID; a DL-RS ID; a cell ID; a global cell ID; and applicable time window. A WTRU may apply a DL-RS configuration under a condition that the current time is within the applicable time window. It is to be understood that reference to an “ID” may be used interchangeably with the term “index.” Examples of a DL-RS may be a channel state information RS (CSI-RS), phase tracking RS (PTRS), positioning RS (PRS), tracking RS (TRS), or synchronization signal burst (SSB).

An uplink RS (UL-RS) or SRS configuration may include at least one of the following: a resource ID; comb offset values; cyclic shift values; a start position in the frequency domain; a number of UL-RS symbols; a shift in the frequency domain for the UL-RS; a frequency hopping pattern; a type of UL-RS (e.g., aperiodic, semi-persistent or periodic); a sequence ID used to generate the UL-RS or other IDs used to generate the UL-RS sequence; spatial relation information indicating which reference signal (e.g., DL-RS, UL-RS, CSI-RS, SRS, DM-RS) or SSB (e.g., SSB ID, cell ID of the SSB) the UL-RS is spatially related to where the UL-RS and DL-RS may be aligned spatially; QCL information (e.g., a QCL relationship between the UL-RS and other reference signals or SSB); QCL type (e.g., QCL type A, QCL type B, QCL type C, QCL type D); resource set ID; a list of UL-RS resources in the resource set; transmission power related information; pathloss reference information which may contain an index for an SSB, CSI-RS or DL-RS; periodicity of the UL-RS transmission; spatial information such as spatial direction information of the UL-RS transmission (e.g., beam information, angles of transmission); or spatial direction information of DL-RS reception (e.g., beam ID used to receive DL-RS, angle of arrival).

A sensing configuration may consist of one or more of a DL-RS or UL-RS configurations. A sensing configuration may consist of measurements or related configurations (e.g., periodicity of measurements or reporting, measurement or reporting trigger conditions, or content of the measurement). A sensing configuration may consist of a combination of RS configurations, measurements, or reporting configurations.

A WTRU may receive a physical broadcast channel (PBCH). The PBCH may be part of a synchronization signal (SS)/PBCH block. The PBCH may carry system information. The PBCH may include or carry a master information block (MIB). An MIB may represent the content, information, payload, and/or bits carried by the PBCH. PBCH and MIB may be used interchangeably herein.

Upon detection and/or reception of an SS/PBCH block, a WTRU may use the information in an MIB on the time and/or frequency resources to find one or more system information blocks (SIB). An SIB may represent content, information, payload, and/or bits. For example, one or more cell reselection parameters may be broadcasted in SIBs (e.g., SIB1, SIB2, SIB3) such that the WTRU may detect and/or receive from the serving and/or the neighbour detected cells.

A WTRU may perform cell selection with or without stored cell information. The cell information may include frequencies and/or cell parameters. For example, a cell may be defined as a combination of one or more uplink component carriers (CCs) and one or more downlink CCs. A WTRU may have previously stored information on one or more cells based on previously received measurement control information elements or from previously detected cells. If a WTRU has stored cell information, the WTRU may leverage it for cell selection.

In the case that a WTRU has no stored information regarding cells or in the case where a desirable cell cannot be found from previous cell history, the WTRU may perform initial cell selection such that the WTRU has no prior knowledge of the cell parameters. For example, a WTRU may no previous indications of which RF channels are NR frequencies. As such, a WTRU may scan and/or monitor one or more RF channels (e.g., from a set of RF channels based on the synchronization raster frequencies) in the NR bands to find a suitable cell. A synchronization raster may indicate the frequency positions of a synchronization block (e.g., SS/PBCH block (SSB)) that may be used by the WTRU for system acquisition when explicit signaling of the synchronization block position is not present. As such, a WTRU may search to find the SSBs corresponding to one and more cells on each frequency channel and/or raster. A WTRU may select the strongest cell based on the measuring the received signal strength indicator (RSSI), reference signal received power (RSRP), reference signal received quality (RSRQ), signal-to-interference-plus-noise ratio (SINR), or other metrics for the detected SSB.

It is to be understood that reference to the term “evaluated parameter” may be used interchangeably with the term “evaluated RSRP,” “evaluated RSRQ,” or other suitable evaluated parameters such that the term evaluated may be interpreted as adjusted, computed, calculated, compensated, scaled, defined, determined, or identified. As such, a WTRU may determine an evaluated parameter based on one or more measured values along with one or more compensation and/or scaling parameters (e.g., configured and/or indicated parameters). A WTRU may calculate the addition, subtraction, multiplication, and/or division of one or more measured values with one or more compensation and/or scaling parameters to determine the corresponding evaluated parameter.

Upon determining a suitable cell, a WTRU may select it as the serving cell. For example, a WTRU may use one or more criteria to select a candidate cell as a suitable cell. A WTRU may determine the criteria based on one or more evaluated parameters. A WTRU may determine the evaluated parameters based on one or more of measured parameters in addition to one or more compensation values, scaling rules, other protocols. For example, a WTRU may determine the compensation values and/or scaling rules based on one or more configured and/or indicated offsets, parameters, or configured values. A WTRU may be configured with, or determine, one or more of the following parameters: a measured cell received power level value; a measured cell quality value; a minimum required measured received (RX) level; one or more compensation values; an evaluated cell reselection RX level value; or an evaluated cell reselection quality value.

For a measured cell received power level value, a WTRU may measure the RSRP, SINR, RSSI, or other related parameters for one or more SS/PBCH blocks, reference signals, and/or channels. For a measured cell quality value, a WTRU may measure the RSRQ for one or more SS/PBCH blocks, reference signals, and/or channels. For a minimum required measured RX level, or quality level in a cell, a WTRU may receive, determine, or be configured with one or more parameters and/or offset values to determine the minimum required RX level (e.g., in dBm) and/or minimum required quality level (e.g., dB) in the corresponding cell.

For compensation values, a WTRU may receive, determine, or be configured with one or more parameters, offsets, and/or scaling values which may be used upon receiving an indication, or based on a determination by a WTRU based on one or more modes of operation or thresholds.

For an evaluated cell reselection RX level value, a WTRU may compute, evaluate, and/or calculate the received level value (e.g., in dB) based on one or more measured parameters, compensation, and/or scaling values. For example, a WTRU may calculate the evaluated cell reselection RX level value (e.g., Sᵣₓₗₑᵥ) based on the measured cell received level value (e.g., Qᵣₓₗₑᵥₘₑₐₛ), the minimum required measured RX level (e.g., Qᵣₓₗₑᵥₘᵢₙ and/or Q_{rxlevminoffset}), the compensation parameters (e.g., P_{compensation}), one or more temporary offset values (e.g., Q_{offsettemp}), or other values (e.g., Sᵣₓₗₑᵥ=Qᵣₓₗₑᵥₘₑₐₛ−(Qᵣₓₗₑᵥₘᵢₙ+Q_{rxlevminoffset})−P_{compensation}−Q_{offsettemp}). As such, a WTRU may select the corresponding cell as one of the candidate suitable cells if the evaluated cell reselection RX level value is higher than a configured threshold (e.g., Sᵣₓₗₑᵥ>0 for cell selection, or Sᵣₓₗₑᵥ>S_{intraSearchP} Or Sᵣₓₗₑᵥ>S_{nonIntraSearchP} for intra-frequency and inter-frequency, respectively such that S_{intraSearchP} may represent an inter-frequency reselection RX level value and S_{nonIntraSearchP} may represent an inter-frequency reselection RX level value).

For evaluated cell reselection quality values, a WTRU may compute, evaluate, and/or calculate the received quality value (e.g., in dB) based on one or more measured parameters, compensation, and/or scaling values. For example, a WTRU may calculate the evaluated cell reselection quality value (e.g., S_{qual}) based on the measured cell quality value (e.g., Q_{qualmeas}), the minimum required quality level (e.g., Q_{qualmin} and/or Q_{qualminoffset}), one or more temporary offset values (e.g., Q_{offsettemp}), or other values (e.g., S_{qual}=Q_{qualmeas}−(Q_{qualmin}+Q_{qualminoffset})−Q_{offsettemp}). As such, a WTRU may select the corresponding cell as one of the candidate suitable cells if the evaluated cell reselection quality value is higher than a configured threshold (e.g., S_{qual}>0, S_{qual}>S_{intraSearchQ}, or S_{qual}>S_{nonIntraSearchQ} for intra-frequency and inter-frequency, respectively).

A WTRU may receive or be configured with one or more of the compensation, scaling parameters, values, settings, and/or rules as the criteria for cell selection via implicit and/or explicit indications. Explicit indications may be via a MIB in the corresponding SS/PBCH block, system information blocks (e.g., SIB1, SIB2, SIB3, SIB4), semi-static configuration (e.g., via radio resource control (RRC)), or dynamic indications (e.g., via MAC control element (MAC-CE) and/or downlink control information (DCI)). A WTRU may determine to use one or more compensation and/or scaling rules based on an implicit indication, that is based on comparing one or more parameters with corresponding thresholds for instance.

After measuring and calculating the evaluated received power and/or evaluated quality values, a WTRU may perform cell ranking for all the cells (e.g., serving and neighbor cells) which the WTRU determined as the candidate suitable cells based on the cell selection criterion. For example, a WTRU may determine the cell ranking based on the calculating the R values using average RSRP results. The following parameters are non-limiting examples of the parameters which may be included in cell ranking calculation and measurement:

$${R}_{s} = {Q}_{m e a s , s} + {Q}_{hyst} - {Q}_{offsettemp} \qquad ( 1 )$$

$${R}_{n} = {Q}_{m eas , n} - {Q}_{offset} - {Q}_{offsettemp} \qquad ( 2 )$$

One or more of these parameters may be included and other parameters may also be included.

Rₛ and Rₙ correspond to the serving and neighbor cells, respectively. For example, in the above equations, Q_{hyst} may represent the mobility aspects of a WTRU. Q_{offset} may be configured with different values for intra-frequency and inter-frequency cell selections, and Q_{meas,s} and Q_{meas,n} may be the measured RSRP quantity used in cell selection for a serving and neighboring cell, respectively. A WTRU may reselect a new candidate cell if the new cell has higher R values than the serving cell during a configured time interval.

A WTRU may be configured with one or more frequencies and associated priorities. For example, absolute priorities of different NR frequencies or inter-RAT frequencies may be provided to the WTRU in the system information, in an RRC release message, or by inheriting another RAT at inter-RAT cell selection. An NR frequency or inter-RAT frequency may be listed without providing a priority (i.e., if cell reselection priority field is absent for that frequency). If any with fields related to a cell reselection priority are provided in dedicated signaling, the WTRU may ignore any fields with related to cell reselection priority provided in system information.

When a WTRU in a normally camped state only has dedicated priorities other than for the current frequency, the WTRU may consider the current frequency to be the lowest priority frequency (i.e. lower than any of the network configured values). When a high-speed data network (HSDN) capable WTRU is in a high-mobility state, a WTRU may consider the HSDN cells to be the highest priority (i.e., higher than any other network configured priorities). When a HSDN capable WTRU is not in a high-mobility state, the WTRU may consider HSDN cells to be the lowest priority (i.e., lower than any other network configured priorities). For example, if a WTRU is configured to perform both NR sidelink communication and V2X sidelink communication, the WTRU may consider the frequency providing both the NR sidelink communication configuration and the V2X sidelink communication configuration to be the highest priority. If a WTRU is configured to perform NR sidelink communication but not perform V2X communication, the WTRU may consider the frequency providing NR sidelink communication configuration to be the highest priority. If a WTRU is configured to perform V2X sidelink communication but not perform NR sidelink communication, the WTRU may consider the frequency providing V2X sidelink communication configuration to be the highest priority. If the WTRU may be configured to perform ranging or sidelink positioning, the WTRU may consider the frequency providing ranging or sidelink positioning configuration to be the highest priority.

A WTRU may apply rules for NR inter-frequencies and inter-RAT frequencies which are indicated in system information and for which the WTRU has priority provided. For example, for an NR inter-frequency or inter-RAT frequency with a reselection priority higher than the reselection priority of the current NR frequency, a WTRU may perform measurements with higher priority using NR inter-frequencies or inter-RAT frequencies.

For an NR inter-frequency with an equal or lower reselection priority or for an inter-RAT frequency with a lower restriction priority than the current NR frequency priority, a WTRU may perform measurements with NR inter-frequency cells of equal or lower priority or on inter-RAT frequency cells of lower priority when a condition is satisfied (e.g., serving cell fulfil Sᵣₓₗₑᵥ<S_{nonIntraSearchP} and S_{qual}<S_{nonIntraSearchQ} conditions).

For an NR inter-frequency with an equal or lower reselection priority than the current NR frequency or for an inter-RAT frequency with a lower reselection priority the current NR frequency, a WTRU may choose not to perform measurements with NR inter-frequency cells of equal or lower priority or inter-RAT frequency cells of lower priority when a condition is not satisfied (e.g., serving cell fulfil Sᵣₓₗₑᵥ>S_{nonIntraSearchP} and S_{qual}>S_{nonIntraSearchQ} conditions).

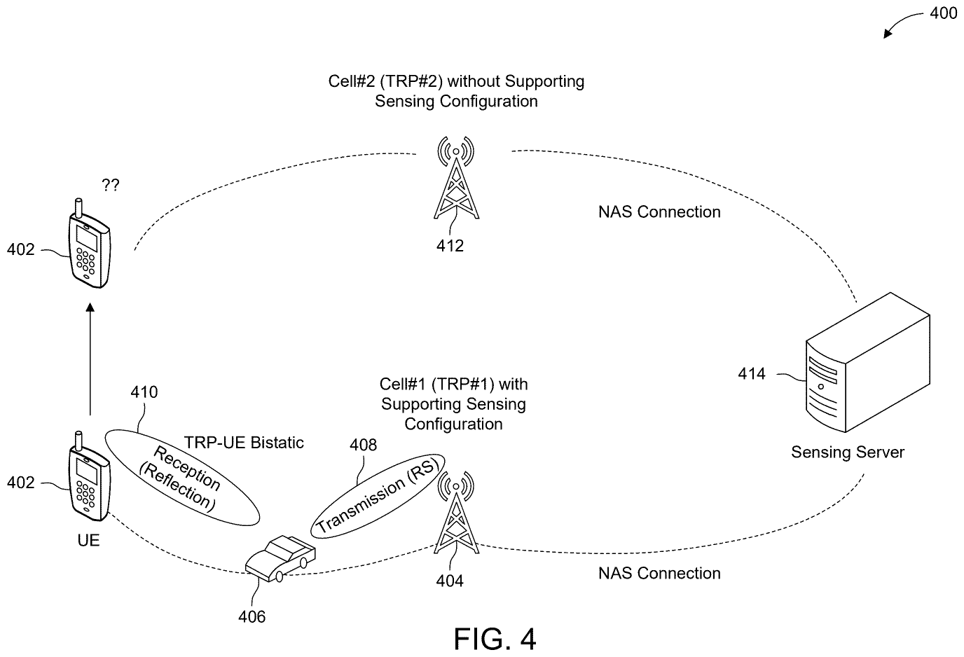

FIG. 4 shows an illustrative scenario of cell reselection for a mobile WTRU, according to one or more embodiments of this disclosure. In scenario 400, WTRU 402 (which may be the same as any of WTRUs 102a-102d or 202) may initially transmit signal 410 which reflects off car 406. Reflected signal 408 may be received by a TRP within cell 404, and data may be sent via non-access stratum NAS connection to sensing server 414 for further processing. However, WTRU 402 may move to a different location. Even if a TRP within cell 412 is closer to WTRU 402, a TRP within cell 412 may not be configured to support sensing. As such, it may not be optimal to switch from using cell 404 to cell 412 without first considering the sensing capabilities for each cell.

For example, in a sensing task, a gNB (or sensing server) may need to configure sensing configurations with at least one DL signal with thresholds for obstacle detection from one or more TRPs of the cells. In some procedures, a WTRU, in an idle or inactive state, is configured with a cell list and associated priorities. The WTRU may reselect a cell based on measurement results from using a cell from the cell list. However, some procedures for reselecting parameters (e.g., cell list, DL-RSRP) are only focused on communication (e.g., data service, congestion) measurements and do not consider sensing measurements with the cell. As a result, a WTRU may be unable perform sensing measurements when it reselects a different cell such that no sensing configuration is available. Moreover, due to the WTRU's mobility, the network may be unable to receive any information on whether the WTRU is determining (e.g., within the cells) sensing measurements. As such, it may be desirable to determine how to support service continuity for sensing measurements for a mobile idle or inactive WTRU.

In certain representative embodiments, when a WTRU performs sensing measurements and cell reselection is triggered, the WTRU performs cell reselection based on performance metrics (e.g., DL measurements) and sensing configuration availability of a cell.

In certain representative embodiments, a WTRU receives one or more configurations for cell reselection from a wireless network. A first configuration may include a first cell list and associated reselection conditions (e.g., a threshold DL-RSRP level). A second configuration may include a second cell list and associated sensing resources (e.g., RS, SSB, PRS, beam index) for sensing measurement.

In certain representative embodiments, a WTRU is configured for performing sensing measurements using a first cell according to a particular sensing configuration. A WTRU may determine that reselection conditions are met based on the first configuration and DL-RSRP measurements. A WTRU may determine a candidate cell list based on DL-RSRP measurements associated with the first cell list and the configured threshold of DL-RSRP levels.

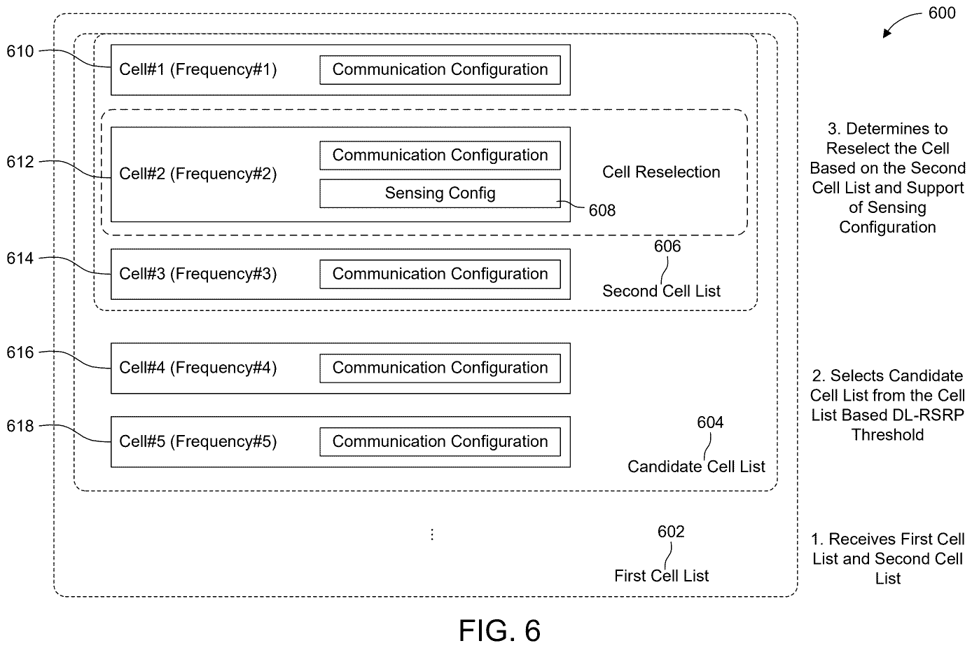

In certain representative embodiments, a WTRU selects a cell based on the candidate cell list and on a second list (as later shown in FIG. 6). A WTRU selects a cell from the candidate cell list with the highest DL-RSRP measurement (or any particular performance metric) that is also included in the second list. A WTRU reselects the selected cell and performs sensing measurements with the reselected cell according to a sensing configuration. A WTRU also reports the sensing measurements with the reselected cell to a wireless network.

In certain representative embodiments, a WTRU selects the best cell from the candidate cell list but none of the candidate cells may be included in a second list. For example, the selected cell may not support a particular sensing configuration. A WTRU reselects to the selected cell and transmits a message to a wireless network indicating that that the WTRU could not reselect to a cell supporting a particular sensing configuration.

In certain representative embodiments, a WTRU reports reselection information to a wireless network. For example, a WTRU may report that cell reselection to a non-best cell occurred because the selected cell did not support a sensing configuration, a request for an updated second cell list, a report with the reselected cell ID, or a current location.

Thus, a WTRU may perform prioritized cell reselection (e.g., supporting a particular sensing configuration) and may report if a sensing configuration of the reselected cell is not available. Based on the solution, a WTRU may support service continuity for sensing measurements, and the network may receive information on whether the WTRU performs sensing measurements within the cells.

It may be understood that reference to a network or wireless network may be used interchangeably with any of the terms AMF, location management function (LMF), LMF-like, gNB, eNB, NG-RAN, CN or sensing server. It may be understood that reference to a sensing server may be used interchangeably with any of the terms AMF, sensing-LMF, LMF-like, or CN.

An LMF is a non-limiting example of a node or entity (e.g., network node or entity) that may be used for or to support positioning or sensing. Any other node or entity may be substituted for LMF (or like-LMF) and still be consistent with this disclosure.

It may be understood that reference to a WTRU may be used interchangeably with any of the terms UE, sensing UE, sensing WTRU, activated sensing UE, activated sensing WTRU, UE with sensing measurement and reporting capabilities or WTRU with sensing measurement and reporting capabilities. It may be understood that reference to a cell (e.g., serving cell, neighboring cell) maybe be used interchangeably with any of the terms intra-frequency, inter-frequency, or frequency.

Regarding timing measurements, an RSTD may be defined by the difference in time of arrival between PRSs transmitted from a reference TRP and a target TRP. A WTRU may be configured with a reference TRP index and a target TRP index. A WTRU may be configured with the PRS resource indices to make measurements. A WTRU may determine the time of arrival from a TRP based on one or more PRS resources associated with the TRP.

An RSTD may be defined as the difference in time of arrival between the reference PRS transmitted from a TRP and the target PRS transmitted from a TRP.

It is to be understood that reference to a WTRU receive-transmit (Rx-Tx) time difference refers to the difference between arrival time of the reference signal transmitted by the TRP and the transmission time of the reference signal transmitted from the WTRU. A WTRU Rx-Tx time difference may be associated with a PRS resource ID and/or SRS resource ID.

Regarding phase measurements, an RSCP (RS carrier phase) may be defined as the carrier phase measurement on the PRS. RSCPD (RSCP difference) may be defined as the difference in carrier phase measurements between two PRS resources.

Regarding power measurements, RSRP per path (RSRPP) may be defined as the RSRP per path if a WTRU observes a multipath channel in the measurement. A WTRU may determine an RSRP for a DL-RS resource. RSRP or RSRPP may be reported using units such as decibel milliwatts (dBm) or as a relative power difference compared to a reference (e.g., RSRP of the first path) in decibels (dB).

In certain representative embodiments, a WTRU may obtain a channel impulse response (CIR) from a network. The network may indicate DL-RS configuration information such as DL-RS resource IDs associated with the CIR. For example, the CIR may be associated with a DL-RS resource ID. In this case, a WTRU may determine that the CIR is derived based on the measurements made on the DL-RS resource associated with an ID. Alternatively, a WTRU may determine that the channel along the direction of transmission of the DL-RS or reception of the DL-RS corresponds to the CIR.

A CIR may be associated with a TRP ID. In this case, a WTRU may determine that the CIR represents the channel between the associated TRP and WTRU. In another example, the CIR may be associated with more than one TRPs, and the network may include TRP indices associated with the CIR. A CIR may be associated with a cell. In this case, the UE may receive cell ID or index associated with the CIR from the network. A CIR may be associated with a cell. In this case, a WTRU may receive a cell ID or index associated with the CIR from the network.

A CIR may be associated with more than one TRPs or DL-RS resource IDs. In this case, a WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

More than one CIRs may be associated with one parameter from DL-RS configurations (e.g., TRP ID, DL-RS resource ID, or frequency layer ID). For example, a WTRU may receive information related to two CIRs associated with a TRP from the network. Alternatively, a WTRU may report information related to more than one CIRs associated with a DL-RS configuration (e.g., TRP ID, or DL-RS resource ID) based on the measurements to the network. There may be more than one CIRs associated with a DL-RS configuration because the WTRU or network may observe different channel characteristics based on the angle of arrival (AoA) of a DL-RS or a UL-RS.

A CIR may be represented by a DP (delay profile) or PDP (power delay profile). A PDP may be defined as a set of delays and power profiles, such as [τ₀, τ₁, . . . , τ_{N-1}] and [p₀, p₁, . . . , p_{N-1}], where pk may corresponds to relative power at the kth path compared to the first path. A delay profile may be defined as a set of delays [τ₀, τ₁, . . . , τ_{N-1}], with respect to a reference timing (e.g., first path, indicated reference timing), which may indicate a path delay for each path. Each path may have a path power above p_{threshold}. A WTRU may receive p_{threshold} from the network to derive a DP from the PDP.

A CIR which a WTRU reports to the network may be defined by configured number of samples such that the WTRU is configured with a granularity of samples (e.g., a certain number of seconds apart). A WTRU may report samples whose RSRP is over a configured threshold or report a certain number of samples with highest RSRP among the samples. A WTRU may indicate locations of samples where the WTRU measures a certain number of highest RSRP samples. The first sample may be defined as the earliest arriving path (e.g., first path). A WTRU may report timing, phase and/or power information per sample.

In certain representative embodiments, a WTRU may receive an indication from the network on how to generate a CIR, PDP or DP based on timing, phase, and/or power measurements. For example, a WTRU may send a request to the network to receive an indication on which methodologies to use to generate a CIR, PDP or DP based on the measurements the WTRU made. A WTRU may receive a message from the network (e.g., via LTE positioning protocol (LPP), RRC, MAC-CE, DCI) indicating that the DL-RS resource indices and associated measurement types (e.g., RSTD, AoA) to use to generate a CIR, PDP or DP. For example, a WTRU may receive an indication from the network indicating to generate a CIR, PDP or DP.

In certain representative embodiments, a WTRU may receive a threshold (e.g., power threshold) from a network and a timing range (e.g., 0 μs to 1 μs), timing granularity (e.g., every 0.1 μs in the indicated timing range or 100 sample points in the indicated timing range) of a CIR, PDP and/or DP. A WTRU may determine to report power and timing (e.g., relative timing compared to a reference timing, absolute timing) information for any samples whose received power is over a threshold. A WTRU may send measurements in a report to the network (e.g., LMF, gNB) via a semi-static (e.g., LPP, RRC) or dynamic message (e.g., uplink control information (UCI), UL MAC-CE).

In certain representative embodiments, a WTRU (e.g., a sensing WTRU or sensing UE) may receive a configuration with the sensing configuration availability of cells from a base station, core network, LMF, or a new entity which supports sensing functions. The sensing configuration of the cells may be configured for one or more WTRUs via non-access stratum (NAS) signaling between a WTRU and core network. The sensing configuration may be configured for one or more WTRUs via signaling between a WTRU and base station. A base station may transmit a message (e.g., sensing configurations/parameters with including conditions) to the WRTUs via RRC SIB and/or RRC dedicated message.

In certain representative embodiments, each of the sensing configurations may comprise at least one associated DL/UL signals with one or more thresholds, UL resources (e.g., reporting of sensing results), periodicities (e.g., when to report sensing results), or reporting conditions. A DL signal may be associated with at least one frequency, a range of resource blocks, or BWP. A DL signal may include at least one of a synchronization signal (SS), secondary synchronization signal (SSS), PBCH, or SSB. In certain representative embodiments, a WTRU may receive a synchronization signal/physical broadcast channel (SS/PBCH) block. The SS/PBCH block (SSB) may include a primary synchronization signal (PSS), SSS, or PBCH. A WTRU may monitor, receive, or attempt to decode an SSB during a sensing operation.

In certain representative embodiments, each of the DL signals may be associated with one or more thresholds. For example, a threshold may be associated with one of measured values (e.g., SSB-RSRP, SSB-RSRQ, SSB-SINR, SS-RSRP, SS-RSRQ, or SS-SINR). Each of the thresholds for each DL signal may indicate an obstacle (i.e., dynamic detection) or building (i.e., semi-static detection). For example, if a measured value is below a threshold (e.g., during a certain duration time), a WTRU may determine that an obstacle has been detected and reports the measured sensing results to the network.

In certain representative embodiments, if a WTRU determines the presence of an obstacle in a sensing area, the WTRU may indicate, to the network, the presence of the obstacle. The WTRU may indicate the presence of an obstacle with a flag (e.g., 1 for presence of an obstacle or 0 for the lack of an obstacle). A WTRU may report DL signals which were used to determine the presence of an obstacle by indicating, for example, SSB or DL RS resource indices or IDs. A WTRU may receive a request from the network to report which DL-RSs or SSBs were used to detect the obstacle.

In certain representative embodiments, a WTRU may be configured with a cell list including a first cell list and/or second cell list by a base station, core network, a new entity supporting sensing functions, LMF, or sensing server. The cell list includes at least one of intra-frequencies, inter-frequencies, physical cell IDs, gNB IDs, or NR cell IDs. The cell list may be associated with a geographical location and/or a location zone.

In certain representative embodiments, a base station may transmit one or more configurations, including one or more cell lists and related parameters or conditions (e.g., cell reselection, sensing resource), via an RRC message to WTRUs, via SIB, via a dedicated message (e.g., RRC release), and/or via NAS message (e.g., cell list(s)) from a core network. A WTRU may be configured with a first cell list via SIB and/or a dedicated message.

In certain representative embodiments, a first cell list may include a suitable or candidate neighboring cell list (or frequency list) and may perform cell reselection with the first cell list according to the cell reselection procedure. The first cell list may be configured with a reselection condition specifying a threshold minimum DL-RSRP level. A WTRU may determine one or more candidate cells from the first cell list based on the received DL-RSRP level (e.g., RSRP/RSRQ) threshold and associated measurement results from the one or more cells of the first cell list. For example, a WTRU may determine one or more candidate cells such that the measured DL-RSRP level of each of the candidate cell is at least above the threshold of the minimum DL-RSRP value.

In certain representative embodiments, a WTRU may be configured, by the network, to process measurements (e.g., DL-RSRP). For example, a WTRU may receive a message (e.g., SIB) to process measurements. To process measurements, a WTRU may be configured to take an average of received DL-RSRP measurements over a configured number of units (e.g., slots, frames, symbols, durations). A WTRU may be configured to make timing (e.g., RSTD) and/or phase measurements. A WTRU may select a cell based on power, timing and/or phase measurements. A WTRU may be configured with thresholds applicable to timing and/or phase measurements. For example, based on timing measurements, a WTRU may determine its proximity to the target or TRP. Examples of the target may be an object within the network or an object a WTRU is configured to track, such as a vehicle, UAV, automated guided vehicle (AGV), human, or animal.

In certain representative embodiments, a WTRU may select a cell based on RSRP per path (RSRPP) or RSRP per sample in the power delay profile. A WTRU may receive an indication from the network to determine RSRPP or RSRP per sample at a delay time or range of times from an indicated reference time (e.g., first path or first detected path).

A WTRU may perform measurements on configured signals (e.g., SSB) or a DL-RS (e.g., PRS). A WTRU may be preconfigured with a list of signals and/or DL-RSs to make measurements. A WTRU may receive the list of signals and/or DL-RSs to measure while the WTRU is in an active or inactive mode. In certain representative embodiment, a WTRU may receive an indication from the network to make measurements using the preconfigured list of signals or DL-RSs once the WTRU is in idle mode.

In certain representative embodiments, the signals a WTRU measures may include characteristics of a target (e.g., a transmitted signal from the TRP is reflected off the target). A WTRU may report to the network (e.g., gNB, LMF) at least one of delay, power delay, or CIR measurements measured on the received signal and/or DL-RS.

In certain representative embodiments, a WTRU may receive a configuration with a second cell list. A second cell list may include available cells to perform sensing measurements with. A configuration with a second cell list may include associated sensing configurations for performing a sensing function with a WTRU. Sensing configurations may include DL sensing resources (e.g., RS, SSB, PRS, beam index), UL resources (e.g., SRS), at least one type of TRP related information (e.g., TRP ID or index), and/or at least one sensing mode (e.g., TRP-WTRU bistatic, WTRU-TRP bistatic). Each of the cells in the second cell list includes sensing configurations associated with at least one TRP and/or sensing resources for performing sensing measurements with a WTRU. For example, cells of the second cell list with associated sensing configuration/resources may be configured with a WTRU via NAS message/signaling (e.g., new radio positioning protocol (NRPP) or LPP) between a WTRU and sensing server and/or via SIB (cell-specific) and/or dedicated RRC message.

In certain representative embodiments, a WTRU may receive measurement configurations from a network via broadcast (e.g., SIB). The measurement configuration may include a periodicity for measurements, signals, DL-RSs to make measurements with respect to a specific duration (e.g., in seconds) of measurements, a start time, and/or end time (e.g., absolute time, relative time with respect to a reference time) for measurements.

In certain representative embodiments, a WTRU may request a configuration for second cell list. For example, a WTRU may request, via NAS message (e.g., sensing area request), to a sensing server and receive the second cell list (e.g., sensing area response) from the sensing server. A WTRU may send a request periodically or based on an event such as being located within or out of the geographical location, receiving an indication of an updated tracking area/registration, or determining a location change via NRPP, LPP, NAS connection setup. A second cell list may include the same cells as the first cell list, may have more cells than the first cell list, may have less cells than the first cell list, may have some of the same cells as the first cell list, or may only have different cells as the first cell list.

In certain representative embodiments, the priority of cell (e.g., neighboring cell/cell list) may indicate an absolute priority of the respective carrier cell or frequency (e.g., inter-frequency for the serving cell or neighboring cell, inter-RAT frequency for the serving cell or neighboring cell). A priority value, for example, may be set between 1 and 8. In certain representative embodiments, the lowest number a priority value may be (e.g., 1) may represent the lowest priority, and the highest number a priority value may be (e.g., 8) may represent the highest priority.

In certain representative embodiments, a list of priority values may be configured with a list of cells or frequencies (e.g., inter-frequency or inter-RAT frequency). The list of priority values and frequencies may be configured with an SIB message (e.g., SIB 2/4/5). Each frequency may be associated with one priority value. Based on the priority value, each frequency may have at least one respective priority level. If the priority value associated with a frequency is low, the frequency may be of low priority. If the priority value associated with frequency is high, the frequency may be of high priority.

In certain representative embodiments, one or more configurations may include a threshold for a priority value in terms of importance. For example, if a threshold priority value is set to 3, the priority values of 1 or 2 would be considered low priority. Otherwise, priority value from 4 to 8 would be considered a high priority value. Based on the priority value threshold, a WTRU may determine whether each frequency is of high priority or of low priority.

In certain representative embodiments, a WTRU may be configured with one or more reselection conditions. For example, a reselection condition may be that a threshold DL-RSRP level or a priority value threshold was exceeded. A WTRU may determine a candidate cell list based on the DL-RSRP level threshold and/or the priority value threshold of the cell. A WTRU may determine a candidate cell list based on determining whether measured DL-RSRP levels and/or priority values of cells exceed a threshold. For example, a WTRU may determine one or more candidate cells when a measured value (e.g., RSRP/RSRQ) and/or if a candidate cell priority value (e.g., the configured threshold value of the cell is 5 and the cell priority value is 7 or 8) of the candidate cell is exceeds a threshold.

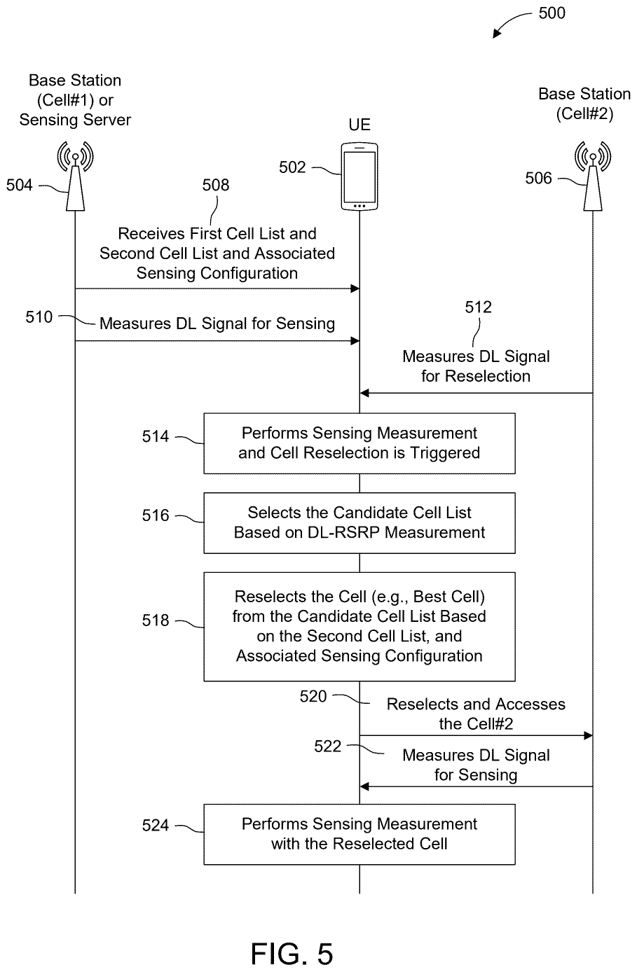

FIG. 5 is a flowchart of illustrative steps for reselecting a cell, according to one or more embodiments of this disclosure. In flowchart 500, WTRU 502 (which may be the same as any of WTRUs 102a-102d, 202, or 402) may receive with a first cell list and a second cell list with associated sensing configurations at 508 from a base station from cell 504. A second cell list may be associated with sensing configurations. At 510, WTRU 502 measures a DL signal for sensing from a base station in cell 504. A sensing resource may be an associated DL resource (e.g., RS, SSB, PRS, beam index) and/or UL resource (e.g., SRS). Each cell of the second cell list may support or provide sensing configurations associated with at least one TRP and a specific sensing resource for performing sensing measurement with the TRP and/or cell. At 512, WTRU 502 measures a DL signal for reselection from a base station in cell 506. At 514, WTRU 502 performs sensing measurements and cell reselection is triggered. At 516, WTRU 502 determines a candidate cell list based on one or more measurements (e.g., DL-RSRP measurements). At 518, WTRU 502 reselects a cell (i.e., a best cell) from the candidate cell list from 516 and based on the second cell list with associated sensing configurations from 508. At 520, WTRU 502 reselects a cell and accesses a base station from cell 506. At 522, WTRU 502 measures a DL signal for sensing from a base station from cell 506. At 524, WTRU 502 performs sensing measurements using the reselected cell (i.e., cell 506).

In certain representative embodiments, a WTRU may use a serving cell (or neighboring cell) when the serving cell provides or supports a particular sensing configuration and sensing resource. In certain representative embodiments, a WTRU may perform sensing measurements via a DL signal when the serving cell supports a particular sensing configuration. For example, a WTRU may measure a DL signal (e.g., DL-RSRP) from neighboring cells/frequencies.

In certain representative embodiments, a WTRU may be configured for sensing measurements and performing sensing measurements based on a sensing configuration using a particular cell. When cell reselection is triggered, a WTRU may determine one or more candidate cells from a first cell list based on the measured DL-RSRP levels for one or more cells of the first cell list (e.g., at least above than the threshold). For example, a WTRU may reselect the best cell (e.g., highest DL-RSRP value) among the candidate cell list (e.g., cell 506). If the best cell is included in the second cell list, then the WTRU may reselect the best cell (e.g., cell 506) which also supports or provides a particular sensing configuration. A WTRU may perform an initial cell access procedure (e.g., random access channel (RACH) procedure) by transmitting a preamble and receiving response from the cell. A WTRU may receive an MIB, SIB or related sensing configurations from the cell (e.g., camping cell or serving cell). A WTRU may continue to perform sensing measurements using a reselected cell (e.g., before or after cell reselection procedure). A WTRU may transmit an indication (e.g., at least 1 bit) or message (via RRC and/or NAS message) to the network indicating sensing cell coverage, support sensing continuity, and/or available sensing measurement results.

FIG. 6 shows a diagram of illustrative cells lists for cell reselection, according to one or more embodiments of this disclosure. In diagram, 600, first cell list 602 may include cells 610-618. Each cell 610-618 may be configured with a communication configuration (e.g., transmitting MIB and/or SIB) but need not be configured with a sensing configuration. In certain representative embodiments, a WTRU performs sensing measurements, and a cell (or frequency) reselection is triggered according to cell reselection conditions (e.g., measured DL-RSRP values of the cell(s)) even if a WTRU is mobile as shown in FIG. 4. A WTRU may determine one or more candidate cells 610-618 (i.e., candidate cell list 604) based on reselection conditions (e.g., threshold of DL-RSRP). A WTRU may reselect the best cell (e.g., the highest DL-RSRP value) of the one or more candidate cells 610-618 based on the measured DL-RSRP values as shown at 516. Candidate cell list 604 includes cells from first cell list 602 which exceed a threshold or satisfy some condition. Reselection may accommodate if the best cell is included in the second cell list. In diagram 600, a WTRU (e.g., any one of WTRUs 102a-102d, 202, 402, or 502) may reselect cell 612 (which may be the same as cell 506) during the cell reselection procedure because cell 612 is the best cell from candidate cell list 604 and is included in second cell list 606 which provides sensing configuration 608.

In certain representative embodiments, a WTRU may report sensing capability information (via RRC and/or NAS message) to a core network. The reporting message on WTRU capabilities may specify at least one of the sensing modes (e.g., TRP-WTRU bistatic, WTRU-TRP bistatic, WTRU-WTRU bistatic, or WTRU monostatic) which the WTRU may support with TRPs, cells, or between WTRUs. A cell may support or provide sensing configurations associated with at least one TRP and at least one sensing mode. A base station may transmit an RRC message including at least one of the supported sensing modes (e.g., TRP-WTRU bistatic, WTRU-TRP bistatic, WTRU-WTRU bistatic, or WTRU monostatic) to the WTRUs via MIB and/or SIB and/or NAS message. When a WTRU triggers cell reselection when performing sensing measurements, the WTRU may reselect a cell providing sensing configurations with a sensing mode that a WTRU may support. For example, a WTRU may select a candidate cell which supports at least one sensing mode that the WTRU also supports.

In certain representative embodiments, when a reselection is triggered, a WTRU may determine to reselect a cell upon receiving information from neighboring or candidate cells (e.g., MIB, SIB, or RRC message). The indication or information from neighboring cells may indicate whether a sensing configuration is supported or not (e.g., as a single bit indication). When a WTRU performs sensing measurements and cell reselection is triggered, the WTRU may determine to reselect a cell which provides a sensing configuration based on the received the information (e.g., supporting sensing configuration) from the neighboring cells.

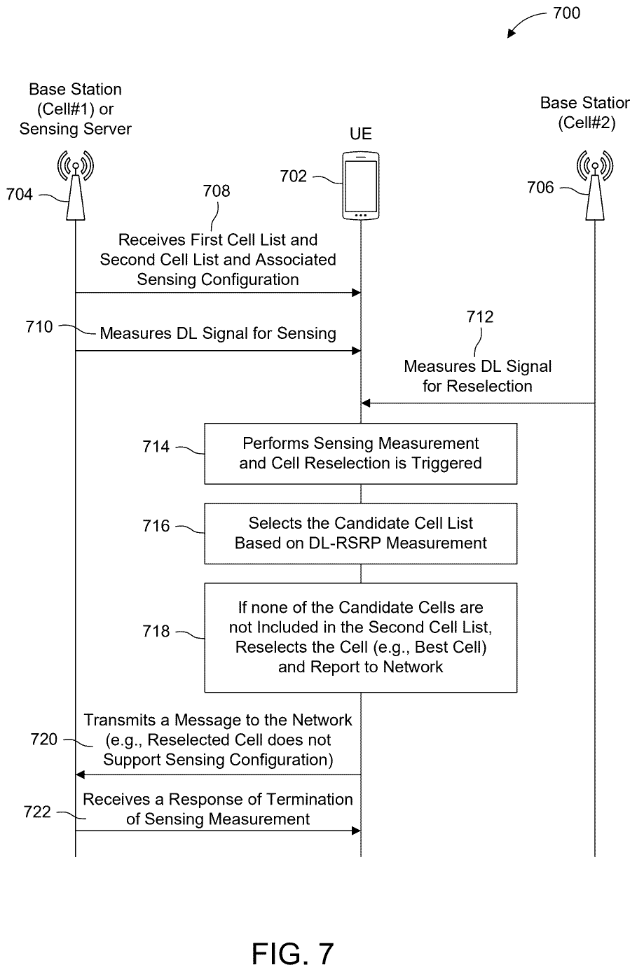

FIG. 7 is a flowchart of illustrative steps for reporting information after cell reselection, according to one or more embodiments of this disclosure. In flowchart 700, WTRU 702 (which may be the same as any of WTRUs 102a-102d, 202, 402, or 502) receives a first cell list and a second cell list with associated sensing configurations at 708 from a base station in cell 704 (which may be the same as cell 504). A second cell list (which may be the same second cell list 606) may be configured with associated DL sensing resources (e.g., RS, SSB, PRS, beam index). Each of the cells of the second cell list may support or provide a sensing configuration associated with at least one TRP and a specific sensing resource for performing sensing measurements with the TRP or cell. At 710, WTRU 702 measures a DL signal for sensing from a base station from cell 704. At 712, WTRU 702 measures a DL signal for reselection from a base station in cell 706 (which may be the same as cell 506). At 714, WTRU 702 performs sensing measurements and cell reselection is triggered. When a cell reselection is triggered, a WTRU may determine one or more candidate cells (which may be the same as cells found in candidate cell list 604) from the first cell list (which may be the same list as first cell list 602) based on a measured DL-RSRP level such that the candidate cells exceed a performance threshold. At 716, WTRU 702 determines a candidate cell list based on DL-RSRP measurements or other performance measurements. At 718, WTRU 702 determines if one of the candidate cells are included in the second cell list. If so, WTRU 702 may reselect whichever cell has the best performance metric and transmits a report to a network. At 720, a WTRU transmits a message to the network indicating that the selected cell does not support a sensing configuration. At 722, WTRU 702 receives a response to terminate further sensing measurements. Operations described in FIG. 7 may also occur in parallel or in addition to operations described in FIG. 5.

In certain representative embodiments, if a reselected best cell (e.g., the cell with the highest DL-RSRP level) from the candidate cell list is not included in the second cell list, then the WTRU searches for another cell (e.g., not the best cell) from the candidate cell list which included in the second cell list. If none of the candidate cell cells are include in the second cell list, a WTRU may reselect the best cell and report its actions to the network. A WTRU may transmit an indication or a message via a (dedicated) preamble, UCI, MAC CE, configured cell group (CG), RRC, or NAS message to the network (e.g., sensing server).

In certain representative embodiments, a WTRU may transmit an indication (e.g., at least 1 bit) to the network indicating that the sensing cell is out of coverage, sensing measurements have been terminated, sensing measurements have been suspended, or an updated cell list has been requested.

In certain representative embodiments, a WTRU may transmit a message indicating to the network that the reselected cell (e.g., best cell) does not provide or support a sensing configuration (i.e., the WTRU may not perform sensing measurements using the reselected cell). A WTRU may include additional information when transmitting the message such that a sensing configuration is not available. For example, a WTRU may include the reselected cell ID (e.g., physical cell ID (PCI), NR ID, frequency index) in the message. A WTRU may include the reselected cell ID with a request to activate a sensing configuration or sensing resource in the message. A WTRU may include positioning information (e.g., geographical and/or zone information) in the message. A WTRU may include the available or supporting sensing modes (e.g., TRP-WTRU bistatic sensing mode or WTRU-WTRU bistatic sensing mode) in the message. A WTRU may include current or previous sensing measurements before reselection was triggered in the message.

In certain representative embodiments, upon transmitting a message indicating to the network that the reselected cell does not provide or support a sensing configuration, a WTRU may receive a response via a DCI, MAC CE, RRC, or NAS message from the network (e.g., sensing server). Upon receiving the response, a WTRU may follow actions according to the received message from the network which may include termination, suspension with a timer value, a preconfigured action, reselection to another cell, reconfiguration with a cell list, or any suitable combination thereof as described below.

In certain representative embodiments, a WTRU may receive an indication to terminate sensing measurements using the reselected cell. Upon receiving the indication of termination, a WTRU may terminate further sensing measurements.

In certain representative embodiments, a WTRU may receive an indication to suspend sensing measurements with the reselected cell with suspension time values (e.g., in slots, milliseconds, or seconds). Upon receiving the indication of suspension, a WTRU may suspend the sensing measurement for some specified suspension time or while a suspension timer is running. Once a WTRU reselects the cell which provides or supports a sensing configuration, the WTRU may stop a suspension timer from running. A WTRU may terminate sensing measurements once a suspension timer has expired such that a specified suspension time has passed. A WTRU need not reselect a cell which provides or supports a sensing configuration while a suspension timer is running.

In certain representative embodiments, a WTRU may receive an indication or activation request to perform sensing measurements based on a pre-configured sensing configuration using a particular DL sensing resource (e.g., RS, SSB, PRS, beam index). The pre-configured sensing configuration may be applied or implemented to be used by a WTRU under certain conditions, for example, such that a cell does not support a sensing configuration or that there is no available cell list. A WTRU may perform sensing measurements with the reselected cell based on the pre-configured DL sensing resource.

In certain representative embodiments, a WTRU may receive an indication to reselect another cell (e.g., not the best cell) which is included in the second cell list (e.g., cells which support a sensing configuration). A WTRU may be configured with conditions to reselect a cell which is included in the second cell list. The activating condition may be whether there is an associated DL data activity, if the WTRU is in a power saving mode, if there is a long discontinuous reception (DRX) cycle, or if a cell in the second cell list has a high priority (e.g., above the threshold of priority value). A WTRU may reselect a cell which is included in the second cell list if a particular condition is satisfied. For example, a WTRU may reselect another cell from the second cell list if there is no UL data activity, if it is in a power saving mode (e.g., no data activity), or if the cell has a priority value which is above a threshold.

In certain representative embodiments, a WTRU may receive an indication to select an additional cell which is included in the second cell list (e.g., cells which support a sensing configuration) for sensing measurements with the additional cell. The received indication or message may include a time configuration (e.g., time gap or periodicity of monitoring) for monitoring the additional cell for sensing measurement. Upon selecting the additional cell, a WTRU may monitor and perform sensing measurements using the additional cell according to a received time configuration. A WTRU may receive cell-related information (e.g., SIB or RRC message) from the reselected cell and may perform sensing measurements with the selected additional cell based on the time configuration.

In certain representative embodiments, upon transmitting the reselected cell ID which does not support sensing configuration to a wireless network, a WTRU may receive a sensing reconfiguration (e.g., via MAC CE, RRC, NAS message) with another cell list with associated sensing configurations. For example, the sensing reconfiguration message may include a new reselection condition (e.g., a threshold of the DL-RSRP level or an offset value of the measurement of the cells). A WTRU may terminate sensing measurements and perform reselection according to the newly updated cell list and associated sensing configurations when a cell reselection is triggered.

In certain representative embodiments, upon transmitting the reselected cell ID which does not support a sensing configuration, a WTRU may receive an indication to activate a sensing configuration using the reselected cell. For example, a WTRU may perform sensing measurements with the reselected cell if the reselected cell provides or supports the sensing configuration.

In certain representative embodiments, upon transmitting positioning reporting (e.g., geographical location or location zones) information, a WTRU may receive a reconfiguration message with another cell list with associated sensing configurations. A WTRU may terminate sensing measurements and may perform reselection according to the newly updated cell list with associated sensing configurations when a cell reselection is triggered.

In certain representative embodiments, if a reselected best cell (e.g., which has the highest DL-RSRP level) from the candidate cell list is not included in the second cell list and the reselected best cell does not support a sensing configuration, a WTRU may perform sensing measurements based on the pre-configured sensing configuration with an associated specified DL sensing resource (e.g., RS, SSB, PRS, beam index) or UL sensing resource (e.g., SRS). For example, the pre-configured sensing configuration may be applied or implemented to be used by a WTRU under certain conditions. For example, a condition may be if a cell does not support a sensing configuration, if there is no available cell list, or if a WTRU receives an indication that the sensing configuration may not be supported temporarily. A WTRU may perform sensing measurements with a reselected cell based on the pre-configured DL sensing resource. For example, a WTRU may report sensing measurement results with an indication that the current sensing measurement results are performed based on a pre-configured sensing resource.

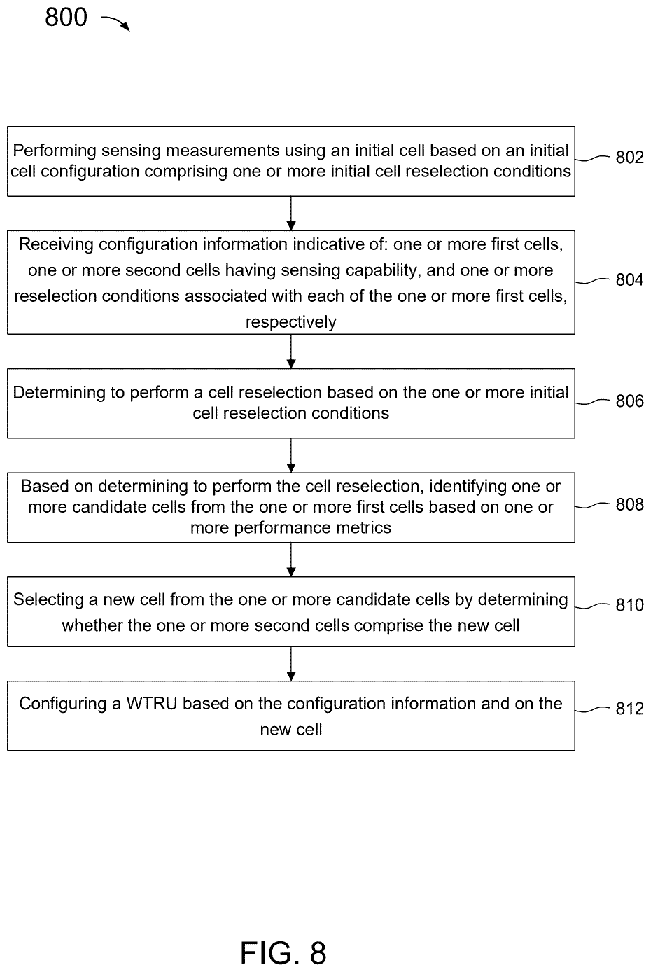

FIG. 8 shows flowchart 800 of illustrative steps for cell reselection, according to one or more embodiments of this disclosure.

At 802, a WTRU (which may be the same as any of WTRUs 102a-102d, 202, 402, 502, or 702) performs sensing measurements using an initial cell based on an initial cell configuration comprising one or more initial cell reselection conditions (e.g., as shown in 508 or 708). In certain representative embodiments, one or more initial cell reselection conditions may comprise exceeding one or more of a DL-RSRP threshold, an RSRQ threshold, an RX quality level threshold, an RSTD threshold, or any other suitable threshold as disclosed herein.

At 804, the WTRU receives configuration information indicative of: one or more first cells, one or more second cells having sensing capability, and one or more reselection conditions associated with each of the one or more first cells, respectively. Reference to the one or more first cells may be in reference to a first cell list (e.g., first cell list 602) and reference to the one or more second cells may be in reference to a second cell list (e.g., second cell list 606). In certain representative embodiments, the one or more first cells and the one or more second cells may each be associated with a location zone.

At 806, the WTRU determines to perform a cell reselection based on the one or more initial cell reselection conditions (e.g., as shown at 514 or 714).

At 808, the WTRU, based on determining to perform the cell reselection, identifies one or more candidate cells from the one or more first cells based on one or more performance metrics (e.g., as shown at 518 or 718). Reference to one or more candidate cells may be a reference to candidate cell list 604.

At 810, the WTRU selects a new cell from the one or more candidate cells by determining whether the one or more second cells comprise the new cell. For example, the WTRU may determine if any cell from second cell list 606 is in candidate cell list 604. In certain representative embodiments, determining whether the one or more second cells comprise the new cell comprises determining that the one or more second cells comprise the new cell and may further comprise performing sensing measurements after the WTRU is configured based on the configuration information and on the new cell. For example, if the new cell is one of the cells of the one or more second cells, then the WTRU may perform sensing measurements using the new cell. In certain representative embodiments, selecting the new cell comprises identifying which of the one or more candidate cells has the best performance based on the one or more performance metrics and is one of the one or more second cells. Reference to the new cell may also refer to a best cell as previously described in this disclosure.

At 810, in certain representative embodiments, the WTRU may determine that the one or more second cells do not comprise the new cell. The WTRU may transmit, to a wireless network, an indication that the new cell is not configured for sensing (e.g., as shown at 718). The WTRU may perform sensing measurements based on the initial cell configuration. It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

At 810, in certain representative embodiments, if the WTRU determines that the one or more second cells do not comprise the new cell, the WTRU may transmit, to the wireless network, a request to receive one or more updated second cells, wherein the one or more updated second cells are not the same as the one or more second cells (e.g., as shown at 720), an identification of the selected new cell, or WTRU location information. In certain representative embodiments, the WTRU may receive a message from the wireless network, wherein the message comprises a second indication to do one or more of the following: terminate performance of sensing measurements (e.g., as shown at 722); suspend, for at least some time, performance sensing measurements; select a first alternative new cell that is not one of the one or more candidate cells, wherein the first alternative new cell has sensing capability; or select a second alternative new cell that is not one of the one or more second cells, wherein the second alternative new cell has sensing capability.

At 810, in certain representative embodiments, selecting the new cell is based at least in part on determining which candidate cell has the best one or more performance metrics. In certain representative embodiments, performance metrics may comprise one or more of a measured RSRPP, RSRP, RSRQ, RSTD, or any other suitable metric disclosed herein.

At 812, the WTRU is configured based on the configuration information and on the new cell.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU), the method comprising:
performing sensing measurements using an initial cell based on an initial cell configuration comprising one or more initial cell reselection conditions;
receiving configuration information indicative of:
one or more first cells,
one or more second cells having sensing capability, and
one or more reselection conditions associated with each of the one or more first cells, respectively;
determining to perform a cell reselection based on the one or more initial cell reselection conditions;
based on determining to perform the cell reselection, identifying one or more candidate cells from the one or more first cells based on one or more performance metrics;
selecting a new cell from the one or more candidate cells by determining whether the one or more second cells comprise the new cell; and
configuring the WTRU based on the configuration information and on the new cell.

2. The method of claim 1, wherein determining whether the one or more second cells comprise the new cell comprises determining that the one or more second cells comprise the new cell, the method further comprising performing sensing measurements after the WTRU is configured based on the configuration information and on the new cell.

3. The method of claim 2, wherein selecting the new cell comprises identifying which of the one or more candidate cells has best performance based on the one or more performance metrics and is one of the one or more second cells.

4. The method of claim 1, wherein selecting the new cell further comprises:
determining that the one or more second cells do not comprise the new cell;
transmitting, to a wireless network, an indication that the new cell is not configured for sensing; and
performing sensing measurements based on the initial cell configuration.

5. The method of claim 4, further comprising transmitting, to the wireless network, one or more of a request to receive one or more updated second cells, wherein the one or more updated second cells are not the same as the one or more second cells, an identification of the selected new cell, or WTRU location information.

6. The method of claim 4, further comprising receiving a message from the wireless network, wherein the message comprises a second indication to do one or more of the following:
terminate performance of sensing measurements;
suspend, for at least some time, performance of sensing measurements;
select a first alternative new cell that is not one of the one or more candidate cells, wherein the first alternative new cell has sensing capability; or
select a second alternative new cell that is not one of the one or more second cells, wherein the second alternative new cell has sensing capability.

7. The method of claim 1, wherein selecting the new cell is based at least in part on determining which candidate cell has the best one or more performance metrics.

8. The method of claim 1, wherein the one or more reselection conditions comprise exceeding one or more of: a downlink-reference signal received power (DL-RSRP) threshold, a reference signal received quality (RSRQ) threshold, a received (RX) quality level threshold, or a reference signal time difference (RSTD) threshold.

9. The method of claim 1, wherein the one or more performance metrics comprise one or more of a reference signal received power per path (RSRPP), reference signal received power (RSRP), RSRQ, or RSTD.

10. The method of claim 1, wherein the one or more first cells and the one or more second cells are each associated with a location zone.

11. A wireless transmit/receive unit (WTRU) comprising:
a processer; and
a transceiver, wherein the WTRU is configured to:
perform sensing measurements using an initial cell based on an initial cell configuration comprising one or more initial cell reselection conditions;
receive configuration information indicative of:
one or more first cells,
one or more second cells having sensing capability, and
one or more reselection conditions associated with each of the one or more first cells, respectively;
determine to perform a cell reselection based on the one or more initial cell reselection conditions;
based on determining to perform the cell reselection, identify one or more candidate cells from the one or more first cells based on one or more performance metrics;
select a new cell from the one or more candidate cells by determining whether the one or more second cells comprise the new cell; and
reconfigure based on the configuration information and on the new cell.

12. The WTRU of claim 11, wherein determining whether the one or more second cells comprise the new cell comprises determining that the one or more second cells comprise the new cell, the WTRU further configured to perform sensing measurements after the WTRU is configured based on the configuration information and on the new cell.

13. The WTRU of claim 12, wherein selecting the new cell comprises identifying which of the one or more candidate cells has best performance based on the one or more performance metrics and is one of the one or more second cells.

14. The WTRU of claim 11, wherein, when selecting the new cell further, the WTRU is further configured to:
determine that the one or more second cells do not comprise the new cell;
transmit, to a wireless network, an indication that the new cell is not configured for sensing; and
perform sensing measurements based on the initial cell configuration.

15. The WTRU of claim 14, further configured to transmit, to the wireless network, one or more of a request to receive one or more updated second cells, wherein the one or more updated second cells are not the same as the one or more second cells, an identification of the selected new cell, or WTRU location information.

16. The WTRU of claim 14, wherein the WTRU is further configured to receive a message from the wireless network, wherein the message comprises a second indication to do one or more of the following:
terminate performance of sensing measurements;
suspend, for at least some time, performance of sensing measurements;
select a first alternative new cell that is not one of the one or more candidate cells, wherein the first alternative new cell has sensing capability; or
select a second alternative new cell that is not one of the one or more second cells, wherein the second alternative new cell has sensing capability.

17. The WTRU of claim 11, wherein selecting the new cell is based at least in part on determining which candidate cell has the best one or more performance metrics.

18. The WTRU of claim 11, wherein the one or more reselection conditions comprise exceeding one or more of: a downlink-reference signal received power (DL-RSRP) threshold, a reference signal received quality (RSRQ) threshold, a received (RX) quality level threshold, or a reference signal time difference (RSTD) threshold.

19. The WTRU of claim 11, wherein the one or more performance metrics comprise one or more of a reference signal received power per path (RSRPP), reference signal received power (RSRP), RSRQ, or RSTD.

20. The WTRU of claim 11, wherein the one or more first cells and the one or more second cells are each associated with a location zone.
